(19) United States
(12) Patent Application Publication
(10) Pub. No.: US 2008/0109253 A1
(43) Pub. Date: May 8, 2008

(54) Method for providing information and obtaining consent

(75) Inventor: Francis D'Ambrosio, Malibu, CA (US)

Correspondence Address: KARL R CANNON, PO BOX 1909, SANDY, UT, 84091, US

(73) Assignee: Explain My Surgery, LLC

(21) Appl. No.: 11/788,194

(22) Filed: Apr. 18, 2007

Related U.S. Application Data
(60) Provisional application No. 60/856,867, filed on Nov. 3, 2006.

(51) Int. Cl. G06Q 50/00

(52) U.S. Cl. 705/2

(57) ABSTRACT

A method of providing information is disclosed for use in facilitating informed consent. The method may include providing a database containing information regarding one or more subjects. Access may be provided to the database through a client, such as a health care provider, to one or more users, such as patients. The users may select a subject for receiving information, and thereafter receive the information over a network. The user may provide feedback regarding the information indicating whether or not the information is understood. A report may be generated and sent to the user and the client. The client may use the report to supplement the information with the user and complete an informed consent form.

### CROSS-REFERENCE TO RELATED APPLICATIONS

This application claims the benefit of U.S. Provisional Application No. 60/856,867 filed Nov. 3, 2006, which is hereby incorporated by reference herein in its entirety, including but not limited to those portions that specifically appear hereinafter, the incorporation by reference being made with the following exception: In the event that any portion of the above-referenced provisional application is inconsistent with this application, this application supercedes said above-referenced provisional application.

### STATEMENT REGARDING FEDERALLY SPONSORED RESEARCH OR DEVELOPMENT

Not Applicable.

### BACKGROUND

1. The Field of the Invention

The present disclosure relates generally to methods and systems for providing information, and more particularly, but not necessarily entirely, to methods and systems for providing information to recipients and for verifying that the recipients receive and comprehend the information to provide consent for an activity.

2. Description of Related Art

Various activities require providing information and obtaining consent prior to undertaking the activity. For example, health care procedures or treatments, such as surgery, often involve a medical care provider supplying information to a patient and obtaining consent from the patient for the treatment. The principles and methods involved with informed consent are also applicable to various other areas in addition to the health care field, such as, participating in sporting or leisure activities, utilizing certain equipment or vehicles, or the purchase of certain assets or other financial transactions, for example. These activities and others may involve the process of providing information to individuals, and obtaining consent from the individuals demonstrating an understanding of the information and acceptance of the risks involved.

Informed consent is a legal procedure to help ensure that a patient or client knows all of the risks or costs involved in a treatment or activity. Elements of informed consents may include informing the patient or client of the nature of the treatment or activity, possible alternatives, and/or the potential risks and benefits of the activity. Usually, in order for informed consent to be considered valid, the patient or client must be competent and the consent should be given voluntarily.

Informed consent documents may be helpful in demonstrating that patients or clients have a suitable understanding of the activity they are to be involved in, as well as the associated risks, benefits, or side effects. Informed consent documents may also be helpful in providing evidence to demonstrate the level of understanding and acceptance of risk on the part of the patient or client. Such documents may also be used in avoiding or resolving disputes that may arise when activity or treatment does not achieve the desired results. Moreover, informed consent procedures may be useful for health care providers or businesses in working with insurance carriers to establish insurance premiums and coverages.

Legal requirements for informed consent may be complicated and may vary from one jurisdiction to another. Accordingly, it may be burdensome to maintain a current understanding of such legal requirements for informed consent. Individuals or businesses may be required to spend an excessive amount of time or resources obtaining informed consent properly to avoid lawsuits. Accordingly, it would be beneficial to streamline the process for providing information to obtain informed consent.

In particular with regard to the healthcare area, medical treatments often result in life altering situations for patients, and the patients often undergo treatments ill prepared for the potential consequences. Accordingly, patients are sometimes disappointed with the outcome of the treatment. Patients may feel that their physician has not explained the risks and benefits of their treatment in a manner that is complete and understandable. Sometimes patients do not understand the terms used by health care providers, the patients may be reluctant to ask for additional explanation or information, and/or the patients may not know what questions to ask. Other times, the health care providers may be in a hurry and may not recognize when a patient may need or desire additional information about a treatment.

A common method for obtaining informed consent from a patient is for the physician or other health care provider to verbally explain a treatment to the patient, or have the patient read information, after which the patient signs a form acknowledging receipt of the information and consenting to the treatment. However, due to the constraints on communication and time, the efficiency and effectiveness of such methods for conveying information may not be optimal. Moreover, the value of informed consents may be reduced.

It would be an advantage to provide a method of conveying information to patients in an easy, yet comprehensive format that may empower patients to make informed decisions regarding their treatments, and to have realistic expectations of the results. It would also be an advantage to provide such a method that would not interfere with the physician-patient relationship, but rather the method of providing information should be one that would augment such physician-patient relationship. It would also be advantageous to provide unbiased information that would not be intended to persuade nor dissuade the patient from having a treatment, but rather to provide an open avenue of communication between physician and patient so that trust and better results can be achieved. It would also be an advantage to provide a method for conveying information that could be used in a broad range of fields in addition to the health care field.

The prior art is characterized by several disadvantages that are addressed by the present disclosure. The present disclosure minimizes, and in some aspects eliminates, the above-mentioned failures, and other problems, by utilizing the methods and structural features described herein.

The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is a flow chart of one embodiment of a method depicting steps that may be used within the scope of the present disclosure;

FIG. 2 is a schematic view of one embodiment of a system using the steps of FIG. 1;

FIG. 3 is an exemplary view of a computer display useful within the principles of the present disclosure;

FIG. 4 is another exemplary view of a computer display useful within the principles of the present disclosure;

FIG. 5 is a flow chart showing possible interactive steps with respect to a patient in one embodiment of the present disclosure;

FIG. 6 is a flow chart showing possible interactive steps with respect to a doctor in one embodiment of the present disclosure; and

FIG. 7 is a representation of one embodiment of a web-site display in accordance with the principles of the present disclosure.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before the present methods and systems for providing information are disclosed and described, it is to be understood that this disclosure is not limited to the particular steps, configurations, and materials disclosed herein as such steps, configurations, and materials may vary somewhat. It is also to be understood that the terminology employed herein is used for the purpose of describing particular embodiments only and is not intended to be limiting since the scope of the present disclosure will be limited only by the appended claims and equivalents thereof.

It must be noted that, as used in this specification and the appended claims, the singular forms “a,” “an,” and “the” include plural referents unless the context clearly dictates otherwise. Moreover, as used herein, the terms “comprising,” “including,” “containing,” “characterized by,” and grammatical equivalents thereof are inclusive or open-ended terms that do not exclude additional, unrecited elements or method steps.

As used herein, the phrase “health care provider” shall be construed broadly to include any variety of practitioners or entities involved in or associated with providing health or medical services.

As used herein, the term “treatment” shall be construed broadly to include the administration or application of remedies to a patient for a condition, disease or an injury, including medicinal or surgical management or therapy.

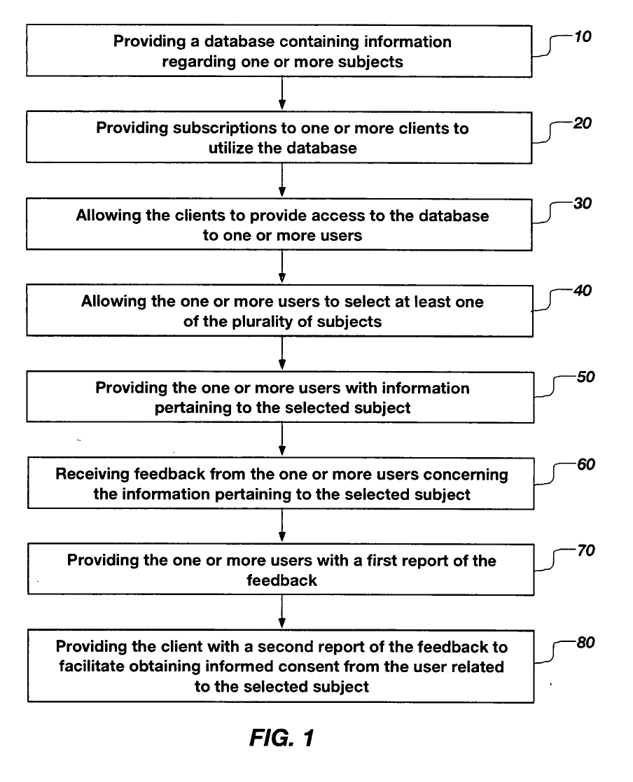

Referring now to FIG. 1, a flow chart is shown, including one embodiment of method steps useful in accordance with the principles of the present disclosure. It will be understood that some embodiments of the present disclosure may not include all of the steps depicted in FIG. 1, and that other embodiments may include additional steps beyond those depicted in FIG. 1. It will also be understood that the order of the steps may vary in accordance with the principles of the present disclosure. Moreover, it will be understood that although the embodiment depicted in FIG. 1 may be discussed in the context of use with a medical treatment, the concepts of the present disclosure are useful for various different fields, such as entering into real estate transactions, contractors agreements, estate plans, or securities transactions, participating in sporting or leisure activities, utilizing certain equipment or vehicles, or the purchase of certain assets or other financial transactions, for example.

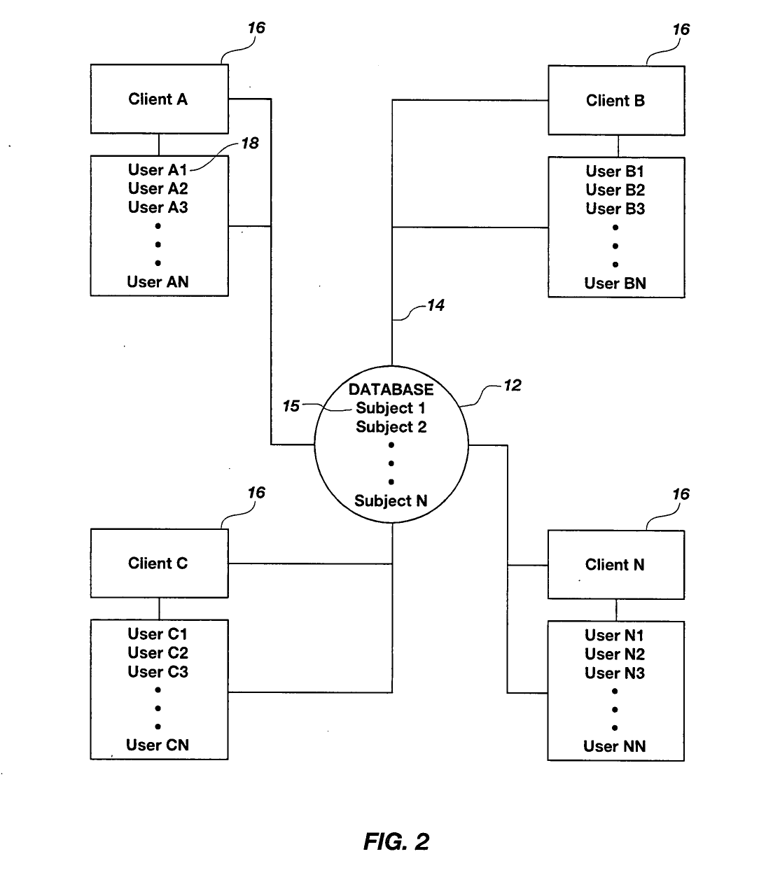

The method depicted in FIG. 1 may include the step 10 of providing a database containing information regarding one or more of subjects. As shown in FIG. 2, which shows a schematic representation of one implementation of the present disclosure, a database 12 containing such information may be provided on a computer, server, or storage device in a manner known in the art. The database 12 may be connected to a network 14, such as a global computer network, the Internet, a wide-area network or a local area network, or any combination of such networks. Alternatively, one embodiment of the present disclosure may include a database on a computer without a connection to a network. It will also be understood that wireless data transmissions may be included within the scope of the present disclosure.

The database 12 may include information regarding one or more subjects 15. For example, the database 12 may include information pertaining to one or more treatments, such as different surgical procedures as represented by subject 1 to subject N in FIG. 2. It will be understood that subject “N” refers to a variable such that any different number of subjects may be included in the database 12. One embodiment of the present disclosure may include a comprehensive compilation of different treatments that a patient might receive. Alternatively, in another embodiment of the present disclosure, the information may focus on a single particular treatment. Information to be provided to one or more users or patients may be developed and stored on the database 12. It will be understood that the subjects 15 may pertain to various different fields in addition to the health care field.

Information pertaining to each of the treatments may be established based on a careful evaluation of legal and/or health requirements for establishing informed consent related to the particular treatment in the relevant jurisdiction. The legal requirements may be based on requirements dictated by local, state, or federal governmental entities, case law, or guidelines sanctioned by relevant organizations, such as the American Medical Association (AMA). Similarly, the information pertaining to each of the treatments may be prepared by experts in the health field in accordance with accepted practices. The information to be provided may be analyzed and formulated based on review by health care professionals and institutions to ensure the completeness and accuracy of the information.

The information may be tailored to be presented at an appropriate level of understanding for the intended audience to ensure that the patient will be able to learn the required information about a particular treatment in order for the patient to legally and ethically be considered to be informed. The information may include subject matter such as an explanation as to why a treatment is done, how the treatment is done, the potential complications and realistic expectations of the results. The information may be designed to empower patients with information to enable them to make informed decisions in light of the risks an benefits of a treatment.

The information in the database 12 pertaining to each subject 15 or treatment may be formulated to be presented in discrete portions, such that understanding of each portion can be assessed individually. Accordingly, if particular portions of the information are more problematic to a patient than others, those portions may be focused upon by the health care provider when explaining the treatment further to ensure that the patient gains a suitable understanding of that information prior to consenting to the treatment.

One embodiment of the present disclosure may include providing a subscription 20 to one or more clients 16 to use the database 12. As used herein, the term “subscription” shall be construed to mean the right or privilege to access the database 12. In some cases the subscription may be granted in exchange for payment of money, goods, or services, whereas in other circumstances the subscription may be provided without payment.

The clients may include health care providers, as represented by clients A to N in FIG. 2. The health care providers or clients 16 may be associated with each other, for example, the health care providers 16 may be employed by the same employer or work at the same location. Alternatively, the health care providers or clients 16 may not be affiliated with each other in any way, and the health care providers or clients 16 may be located remotely from each other. Accordingly, the principles of the present disclosure may be useful for a wide range of clients 16 or health care providers, including large institutions with numerous health care providers as well as clients comprised of a sole practitioner. Moreover, the number of clients 16 that may be provided access to the database 12 may be virtually limitless, and the clients 16 may be other entities besides health care providers, such as any type of entity that may want to provide information and/or obtain consent.

In one embodiment of the present disclosure, the health care providers or clients 16 may be required to pay a periodic fee, such as an annual fee, for the subscription or privilege of having access to the database 12. The health care provider or client 16 may be given unlimited access to the database 12 for the period. Alternatively, it will be understood that the client 16 may be charged a fee for each particular use of the database 12, or the duration of the period may vary. It will also be understood that other alternative embodiments may not require the client 16 to pay a fee.

The method may also include the step 30 of allowing the clients 16 to provide access to the database 12 to one or more users 18 or patients. It will be understood that as shown in FIG. 2, Client A may have any number of users 18, as represented by users A1 to AN, to which access to the database 12 may be allowed. Similarly, the Clients B to N, may also have any number of users 18 to which access to the database 12 may be allowed.

It will be understood that the user 18 may obtain access to the database 12 via a computer connected to the database 12 through the network 14, in a manner known in the art. It will be understood that any other data retrieval device, such as a telephone, a personal digital assistant (PDA), or the like, may be used in accordance with the principles of the present disclosure. Similarly, any variety of input device, such as a keyboard, keypad, mouse, or audio recognition system, or the like, may be used by the user 18 to interact with the database 12. One embodiment of the present disclosure allows the user 18 to access the database 12 at a location remote from the database 12 or client 16 in the comfort of the user's own home if desired, or any other location where the user 18 can obtain a connection to the network 14 or Internet. Accordingly, the user 18 can feel more comfortable accessing the database 12 and may be more at ease and receptive to learning the information available on the database 12. Embodiments of the present disclosure may be used to reduce anxiety of the user 18 and to increase comprehension of the information presented.

In one embodiment of the present disclosure, each of the clients 16 may have a username and/or password to allow access to the database 12, such that each of the users 18 of the particular client 16 may be able to use the same password. Alternatively, each of the clients 16 may have a plurality of passwords to provide to users 18 such that each of the users 18 may be provided with a different password to allow access to the database 12. Moreover, other embodiments may allow access to the database 12 by the users 18 independent from the clients 16. It will also be understood that alternative embodiments may not require a password to access the database 12, but rather may allow unrestricted public access to the database 12 or at least portions of the database 12.

One embodiment of the present disclosure may require the client 16 to provide information regarding the user 18 to sign in or register. For example, the health care provider or client 16 may be required to provide identifying information, such as a name or identification number, a correspondence address or the like. Other embodiments may not require the health care provider or client 16 to provide any such identifying information, or such information may be provided by the patient or user 18.

One embodiment of the present disclosure may include the step 40 of allowing the one or more users to select at least one of the plurality of subjects. For example, if the health care provider or client 16 has prescribed a particular treatment for the patient or user 18, the patient may select the particular subject 15 or treatment from the plurality of treatments with information available on the database 12. Any suitable input device, as described above, may be used by the patient to select the desired treatment for which information is to be received. Alternatively, the particular subject matter to be provided to the patient may be selected by the health care provider such that the patient may have access to receive only the information chosen by the health care provider.

The present disclosure may include the step 50 of providing the one or more users 18 or patients with information pertaining to the selected subject 15. It will be understood that the information stored on the database 12 and provided to the user 18 may include any variety of presentation formats. For example, the information may be provided in written text, available for reading by the user 18. Some embodiments may include text in different languages such that the user 18 can select a desired language for receipt of the information. The information may also be in the form of audio recordings, or visual representations, such as diagrams, pictures, motion pictures, graphs and the like, or any suitable combination of such presentations or multi media may be used.

The information provided to the user 18 may be conveyed in one or more discrete segments or portions. Accordingly, each segment may be received by the user 18 at the user's own pace. Moreover, the amount of information provided in each segment may be formulated to have a duration that is not so long as to overwhelm or bore the user 18, or not so brief as to provide inadequate or disjointed information. Moreover, the plurality of segments may be configured to allow the user 18 to more easily end the session and resume at a later time by starting at a particular segment, rather than wasting time going through the entire session to find the location where the previous session was terminated. In one embodiment, the user 18 may receive or replay each segment as many times as desired until the user 18 is satisfied with his or her understanding of the segment, or until the user 18 chooses to continue with the next segment of the information and have a more detailed explanation provided by the client 16.

As previously discussed, in one embodiment, the user 18 may be able to receive the information in the comfort of his or her own home or any other location where the user 18 has access to the network 14, such as the Internet. Accordingly, the comfort of the user 18 may be more conducive to allowing the user 18 to gain an understanding the information presented. Alternatively, it will be understood that the information may be provided to a patient at a health facility, such as a hospital, clinic, or doctor's office. In such case, the health care provider may be more readily available to supplement the information provided to the patient.

The present disclosure may include a step 60 of receiving feedback from the one or more users 18 concerning the information pertaining to the selected subject 15. For example, once a particular segment or portion of the information is presented, the user 18 may be asked if he or she understands the information. The user 18 may be allowed to respond, such as by indicating, “yes,” “no,” or “maybe,” for example. In one embodiment, when a user 18 indicates affirmatively that the information is understood, the next segment of information may automatically be provided. Alternatively, the user 18 may be allowed to select a “next” option for the next segment of information to be provided. Similarly, if the user 18 indicates that the information is not understood, additional explanation of the segment may automatically be provided. The user 18 may be given an additional opportunity to indicate whether or not the user 18 understands the information.

Alternative embodiments of the present disclosure may allow other responses, such as a rating of the level of understanding on a scale of one to five, or providing specific answers or questions, for example. One embodiment of the present disclosure may allow a user 18 to select an option of receiving more detailed information regarding the selected treatment or other related topic. Links may be provided to any variety of related topics. Accordingly, additional detail or background may be provided as needed such that the user 18 can choose to receive more or less information specifically tailored to the user's individual needs.

It will be understood that the feedback may be provided by the user 18 in any suitable manner known in the art, such as by keying in the desired response on a keyboard or keypad, clicking on a desired response with a mouse, providing a verbal indication to a audio recognition system, or operation of any other feedback system known to those skilled in the art.

The feedback for each portion of the presentation may be stored on a storage device through the network 14. The user 18 may then proceed to the next portion of the information to receive additional information. This may be accomplished in any manner known in the art, such as by selecting a “next” button, or entering a command, or automatically upon selection of a response, for example. A mechanism may also be provided to return to a previous portion of the information, or to access any other portion of the information to move ahead or backwards. Accordingly, the user 18 may be able to review or change feedback at a subsequent time. One embodiment of the present disclosure may include creating a record of all of the changes made by the user 18 to the feedback, and all the information provided to the user 18. Thus, a history of the information provided to the user 18 and the feedback responses by the user 18 may be stored for use if desired.

One embodiment of the present disclosure may include a completion procedure. If a user 18 completes a receipt of information regarding a subject, the user may be asked to confirm completion. If the user 18 confirms that he or she has completed the receipt of information, the feedback from the user 18 may be locked such that future changes to the feedback may not be allowed. It will be understood that alternative embodiments of the present disclosure may allow a user 18 to change responses at any time.

The principles of the present disclosure may also involve the step 70 of providing the one or more users or patients with a first report of the feedback. For example, when the user 18 has received all of the information regarding the selected subject, or the user 18 otherwise wishes to finish or terminate receipt of the information and receive a report of the information received, the user 18 may receive such report. The first report may include a listing of the subject matter provided to the user 18 as well as the feedback provided by the user 18. One feature of the present disclosure allows the user 18 to have a report presenting questions developed while receiving the information. Accordingly, the user 18 or patient may utilize the questions to more efficiently and fully communicate with the health care provider to gain a better understanding of a treatment. The report may also be provided in the form of a certificate indicating completion of receipt of the information, or an additional certificate of completion may be provided in addition to the report. It will be understood that alternative embodiments may include various different items of information that may be useful for the user 18. The report may be provided in an electronic format, and/or the report may be provided in a manner to allow the report to be printed to provide a hard copy in a manner known to those skilled in the art.

The principles of the present disclosure may also involve the step 80 of providing the client 16 or health care provider with a second report of the feedback. For example, the health care provider may be provided with a report similar to the report provided to the user 18. Accordingly, the health care provider may be apprised of the patient's receipt of the information, as well as the patient's feedback. In a health care provider's busy practice, it may be difficult to spend the time necessary to help each user 18 understand the risks and benefits of treatments such as surgery. The principles of the present disclosure may be used to provide the user 18 with information and a list of questions for the health care provider, so that the user 18 can obtain reasonable expectations and not be surprised by the potential adverse outcomes of the treatment. The health care provider may be provided with a report and have record of what information the patient received, and which of the separate portions of information, if any, should be supplemented so that the user 18 can be truly informed. This may facilitate subsequent communication between the health care provider and the user 18. The health care provider may therefore be allowed to focus on the aspects that may be most beneficial to the user 18 in order to make communications with the user 18 more efficient and meaningful.

In one embodiment of the present disclosure, the second report may be submitted to the health care provider 18 through an electronic mail procedure. The health care provider may automatically be notified that the patient has completed an informational session. The health care provider may then access the second report, as the results of the patient's informational session may be stored on a database accessible by the health care provider 18 through the network 14. In such case, it will be understood that suitable security provisions may be utilized to ensure that such information may be maintained confidential. Alternatively, the health care provider may be automatically provided with a copy of the results of the patient's informational session. The health care provider may also or alternatively be provided with a hard copy of the report. One embodiment of the present disclosure may be configured such that the client 16 may not be allowed to alter the feedback from the user 18. Accordingly, the second report may be preserved as accurate evidence of the actual feedback of the user 18.

One embodiment of the present disclosure may provide for allowing the client 16 to access portions of the database 12 not accessible to the users 18. Moreover, security provisions may be provided to prevent the clients 16 from accessing data on the database 12 pertaining to users 18 associated with other clients 16. Similarly, security provisions may be provided for allowing public access to a portion of the database 12, and providing the clients 16 with access to a portion of the database 12 that is not accessible to the public or the users 18, and providing access to the database 12 to the users 18 that is not accessible to the public or the client 16.

It will be understood that the principles of the present disclosure may be used to facilitate the “informed consent” process. Information obtained by the user 18 in accordance with the principles of the present disclosure may be improved as compared to prior art methods, such that the user 18 may be more informed regarding a potential treatment and better able to make proper decisions. Also, the principles of the present disclosure may be helpful for health care providers 16 to properly convey needed information. Accordingly, the patient-physician relationship may be improved.

It will be understood that informed consent forms may be completed and signed in a traditional manner following the methods in accordance with the principles of the present disclosure. For example, the user 18 may meet with the client 16 to discuss pertinent information required for completion of the informed consent form, based on the results of the informational session. Alternatively, it will be understood that the principles of the present disclosure may be utilized to generate an informed consent form. The informed consent form may be customized for a pertinent jurisdiction, including information or certifications to correspond with statutes or other requirements of the particular jurisdiction. Such informed consent form may be stored on the database 12 and retrieved as desired, or automatically produced upon completion of the informational session. The informed consent form may be signed by an electronic signature mechanism known in the art, and also stored on the database 12. Alternatively, the informed consent form may be printed and signed in a customary manner. One embodiment of the present disclosure may include providing for a signature of one or both of the user 18 and the client 16 for each of the areas where additional information was sought or provided. The completed informed consent form may be scanned and stored electronically in a manner known in the art, or a hard copy of the completed informed consent form may be stored in a customary manner.

It will be understood that the principles and methods of the present disclosure may also be useful in situations not involving informed consent. For example, inquisitive patients who want to know more about a particular treatment for themselves or others may find the principles of the present disclosure useful. Similarly, the principles of the present disclosure may be useful in other fields in addition to the health care field such as, participating in sporting or leisure activities, utilizing certain equipment or vehicles, or the purchase of certain assets or other financial transactions, for example.

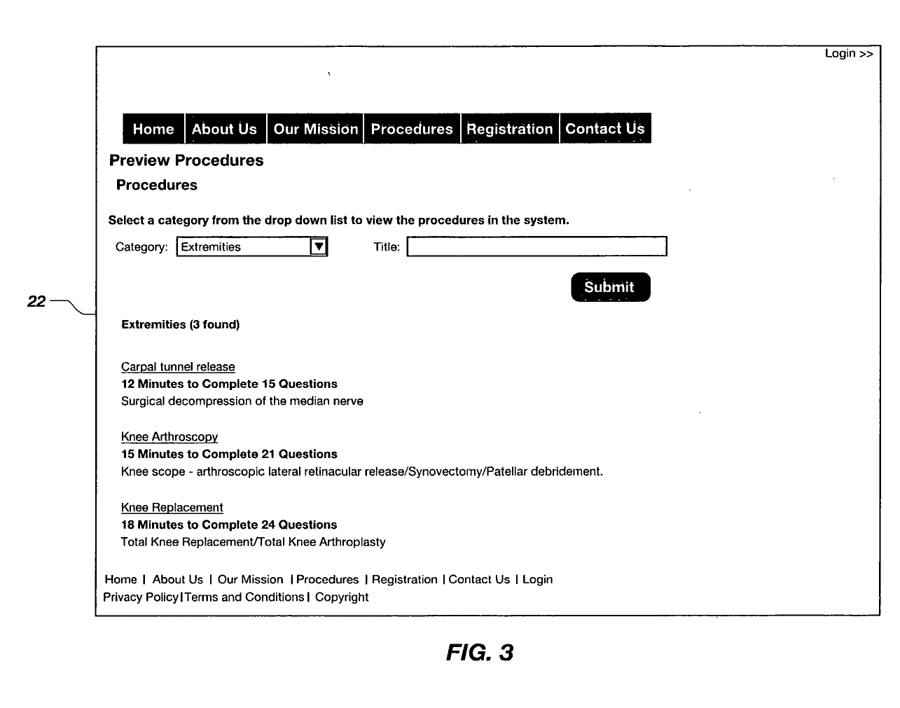

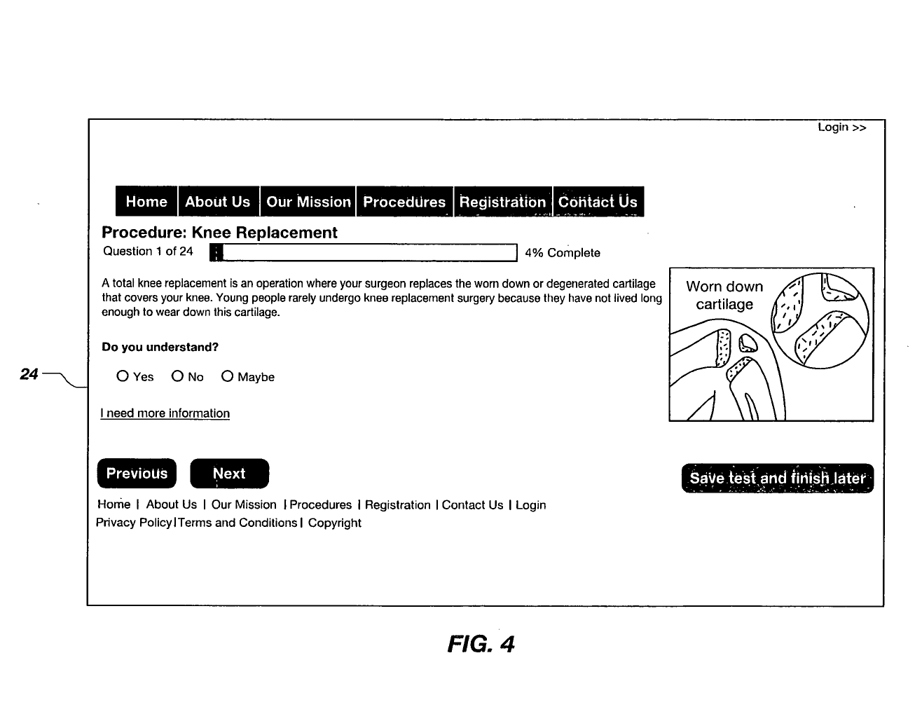

Referring now to FIGS. 3 and 4, an exemplary embodiment of one implementation of the principles of the present disclosure is provided. It will be understood that the example provided herein is intended to be illustrative only, and is in no manner intended to be limiting of the present disclosure. In this example, a health care provider has examined a patient and indicated that the patient is in need of a knee replacement. The health care provider has registered with the information service incorporating the methods described herein. The health care provider provides an access user name and password to the patient. The patient is allowed to access the database in the convenience of the patient's home or where ever the patient has access to the Internet. The patient accesses a web site containing the information regarding knee replacements as well as numerous other surgical procedures. It will be understood that one embodiment of the present disclosure may include a public portion of the website that may be developed to address questions of anyone who visits the site, such as patients, doctors, health care providers, and potential advertisers. The public portion of the website may also serve as a portal for clients or users who have non-public access to the website. The website may provide instructions to the user to select a category from a drop down list to view the available procedures available on the system. The procedures may be separated in a plurality of categories, such as those related to the head, neck, chest, abdomen, pelvis, back, extremities, and miscellaneous. The patient may select surgical procedures related to extremities to see a list of surgical procedures related to such category, including knee replacement surgery, as shown most clearly in the representation depicted on a computer display 22 shown in FIG. 3. The patient may alternatively enter a title of the surgical procedure to search for and access the information related to a knee replacement.

The patient may select the desired treatment from the list of available procedures. Each of the listed procedures may include an estimate of the amount of time required to complete the session, as well as the number of questions or informational segments provided, or other identifying information regarding the surgical procedures. Once the patient selects “knee replacement” from the list of surgical procedures, a page may be displayed to present the first segment of information regarding knee replacement surgery, as shown the example representation of the computer display 24 in FIG. 4. The patient receives the information provided in the first segment of the presentation at the patient's own pace. When the patient has finished with the first segment of the presentation, the patient responds to the question: do you understand? The patient may select responses “yes,” “no,” “maybe,” or “I need more information.” The patient may also select options such as “next,” “previous, ” or “save and finish later.” If the patient understands the information and selects “yes,” the patient may proceed to the next step or segment of the presentation. If the patient does not understand the information and selects “no,” “maybe,” or “I need more information,” additional information may be presented to attempt to explain the segment in greater detail. Another opportunity will be provided to the patient to allow the patient to indicate whether or not the patient understands the information. If the patient still does not understand the information and so indicates, the next step or segment of the presentation may then be provided.

The patient proceeds with the presentation until all of the steps or segments have been presented. A certificate of completion may then be generated. Also, a report may be printed containing all of the patient's responses. A report may also be stored electronically and notice sent to the health care provider that the patient completed the session and a report of the session is available. The patient may review the report and thereby have a list of questions or topics for which the patient desires additional information. The patient and health care provider may then be able to meet to provide the patient with any follow up information in an efficient manner. An informed consent form may also be signed by the patient following the information presentation.

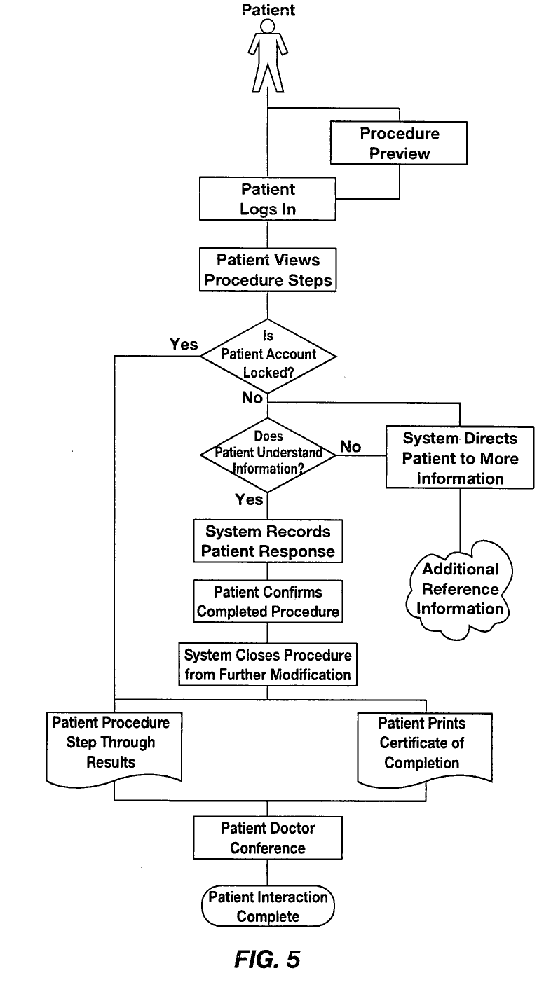

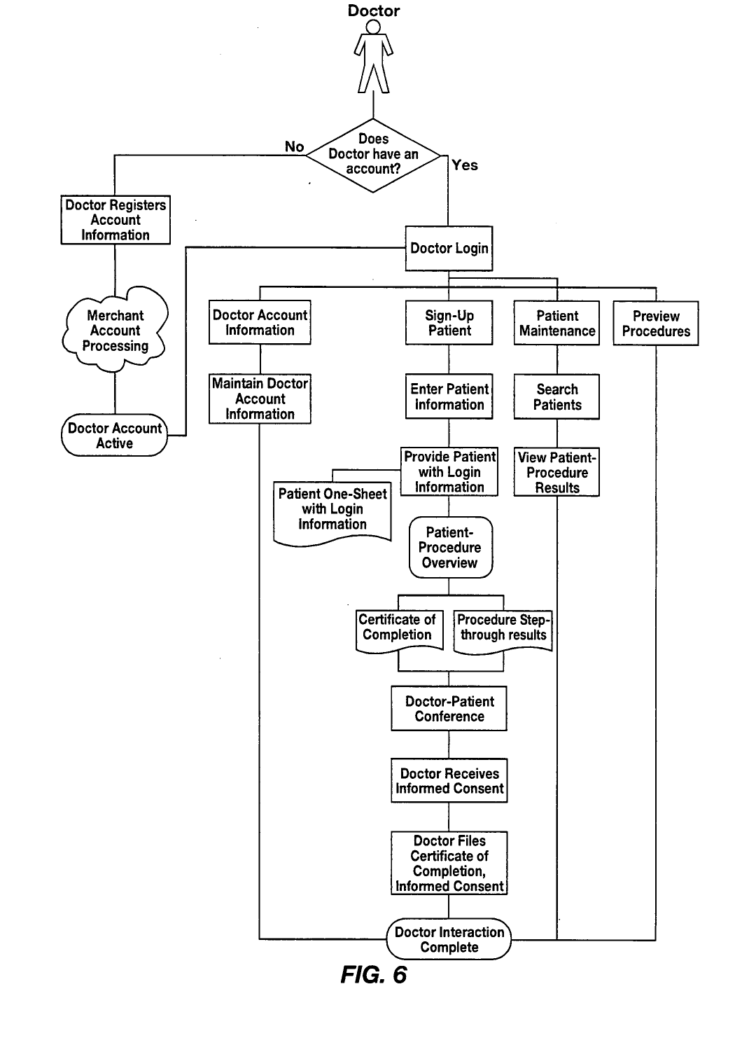

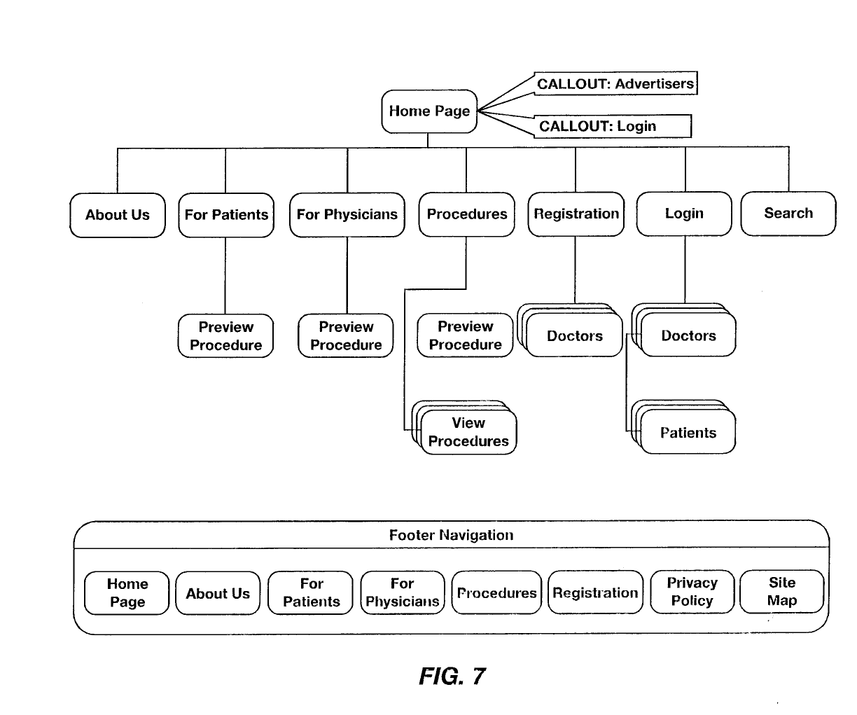

A flow chart showing one embodiment of possible interactive steps with respect to a patient is shown in FIG. 5. FIG. 6 shows a flow chart showing possible interactive steps with respect to a doctor in one embodiment of the present disclosure. FIG. 7 is a representation of one embodiment of a web-site display in accordance with the principles of the present disclosure. It will be understood that the features depicted in FIGS. 5-7 are for illustrative purposes only, and are not intended to limit the scope of the present disclosure.

One embodiment of the present disclosure may include tracking usage of the database 12 by the clients 16 and/or the users 18 so that statistical information related to use of the database 12 or a website using the database 12 can be created. For example, information regarding the page views per day, number of visitors per day, website entry and exit pages and referral information may be gathered. The clients 16, advertisers, or other interested parties may desire the statistical information such that the statistical information may be utilized to promote usage and support for systems and methods utilizing the principles of the present disclosure.

One embodiment of the present disclosure may also provide an administrative feature which may allow administrators to enter, edit, and assign advertisers to different portions of the website, or to add or revise the subjects, questions, information, or format of the website, or to accomplish any other administrative tasks. The administrative feature may not be accessible to clients 16 or users 18 without authorization.

It will be appreciated that the structure and apparatus disclosed herein is merely one example of a means for performing a specified function, and it should be appreciated that any structure, apparatus or system which performs functions the same as, or equivalent to, those disclosed herein are intended to fall within the scope of a means for performing the specified function, including those structures, apparatus or systems for performing the function which are presently known, or which may become available in the future. Anything which functions the same as, or equivalently to, a means for performing the specified function falls within the scope of that element.

In accordance with the features and combinations described above, a useful method of providing information for use in obtaining informed consent may include the steps of:

providing a database containing information pertaining to a subject;

allowing a client to utilize the database;

providing access to the database to one or more users associated with the client;

providing the one or more users with the information pertaining to the subject from the database;

receiving feedback from the one or more users concerning the information pertaining to the subject;

providing the one or more users with a first report of the feedback; and

providing the client with a second report of the feedback such that the client and the one or more users can communicate to supplement the information pertaining to the subject based on the feedback to obtain informed consent from the one or more users related to the subject.

Those having ordinary skill in the relevant art will appreciate the advantages provide by the features of the present disclosure. For example, it is a feature of the present disclosure to provide a method and system for providing information that is simple in design and use. Another feature of the present disclosure is to provide such a method that can be used in various different locations, such as in the comfort of a patient's own home. It is a further feature of the present disclosure, in accordance with one aspect thereof, to provide a method of providing information that may enhance the efficiency of communication between a health care provider and a patient, and augment the physician-patient relationship. It is another feature of the present disclosure to provide a method of providing information that improves the effectiveness of informed consent. It is another feature of the present disclosure to provide a method for conveying information in an easy, yet comprehensive format that will empower patients to make an informed decision regarding their treatments and to have realistic expectations of the results. The method may be configured to neither persuade nor dissuade the patient from having a treatment, but rather to open the avenue of communication between physician and patient so that trust can be achieved. It is a further feature of the present disclosure to provide a method for providing information that can be used in a wide variety of fields, in addition to the health care field, covering information on various different topics.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A method for providing information for use in obtaining informed consent, said method comprising:
providing said information on a database;
providing access to said information to one or more users associated with a client;
receiving feedback from said one or more users concerning said information;
providing said one or more users with a first report of said feedback; and
providing said client with a second report of said feedback such that said client and said one or more users can communicate to supplement said information based on said feedback to obtain informed consent from said one or more users related to said information.

2. The method of claim 1, wherein providing said information on a database comprises providing information pertaining to a plurality of subjects.

3. The method of claim 2, wherein providing information pertaining to a plurality of subjects further comprises providing information pertaining to a plurality of treatments.

4. The method of claim 3, wherein providing information pertaining to a plurality of treatments further comprises providing information pertaining to a plurality of surgical procedures.

5. The method of claim 3, further comprising allowing said one or more users to select said information pertaining to one of said plurality of treatments.

6. The method of claim 1, further comprising providing said database on a global computer network.

7. The method of claim 1, further comprising providing subscriptions to a plurality of clients to utilize said database.

8. The method of claim 7, further comprising allowing said plurality of clients to provide access to said database to said one or more users.

9. The method of claim 1, further comprising providing said information to said one or more users in a plurality of separate segments.

10. The method of claim 9, further comprising providing one of said plurality of segments after said one or more users indicates an understanding of a preceding segment.

11. The method of claim 9, further comprising providing said one or more users with an option of receiving additional information pertaining to said segments.

12. The method of claim 1, further comprising providing said information in at least one of a group consisting of written text, audio recordings, and visual representations.

13. The method of claim 1, further comprising providing notice to said client when said second report is available.

14. The method of claim 1, further comprising storing said first report and said second report on said database.

15. The method of claim 1, further comprising allowing said client to assign a username and password to said one or more users.

16. The method of claim 1, further comprising allowing said client to access portions of said database not accessible to said one or more users.

17. The method of claim 7, further comprising preventing each of said plurality of clients from accessing data on said database pertaining to users associated with other clients.

18. The method of claim 1, further comprising allowing public access to a portion of said database, and providing said client with access to a portion of said database that is not accessible to said public or said one or more users, and providing access to said database to said one or more users that is not accessible to said public or said client.

19. The method of claim 1, further comprising providing access to said information to said client.

20. The method of claim 1, wherein providing said information on said database comprises providing information pertaining to a plurality of subjects;
wherein providing information pertaining to a plurality of subjects further comprises providing information pertaining to a plurality of treatments;
wherein providing information pertaining to a plurality of treatments further comprises providing information pertaining to a plurality of surgical procedures;
further comprising allowing said one or more users to select said information pertaining to one of said plurality of treatments;
further comprising providing said database on a global computer network;
further comprising providing subscriptions to a plurality of clients to utilize said database;
further comprising allowing said plurality of clients to provide access to said database to said one or more users;
further comprising providing said information to said one or more users in a plurality of separate segments;
further comprising providing one of said plurality of segments after said one or more users indicates an understanding of a preceding segment;
further comprising providing said one or more users with an option of receiving additional information pertaining to said segments;
further comprising providing said information in at least one of a group consisting of written text, audio recordings, and visual representations;
further comprising providing notice to said client when said second report is available;
further comprising storing said first report and said second report on said database;
further comprising allowing said client to assign a username and password to said one or more users;
further comprising preventing each of said plurality of clients from accessing data on said database pertaining to users associated with other clients;
further comprising allowing public access to a portion of said database, and providing said client with access to a portion of said database that is not accessible to said public or said one or more users, and providing access to said database to said one or more users that is not accessible to said public or said client;
wherein said client comprises a health care provider, and wherein said one or more users comprise patients.

21. A method for providing information for use in obtaining informed consent, said method comprising:
providing subscriptions to said information to one or more clients;
allowing said one or more clients to provide access to said information to one or more users;
receiving feedback from said one or more users concerning said information;
providing said one or more users with a first report of said feedback; and
providing said one or more clients with a second report of said feedback such that said one or more clients and said one or more users can communicate to obtain informed consent regarding said information.

22. The method of claim 21, further comprising providing said information on a database.

23. The method of claim 22, further comprising providing said database on a global computer network.

24. The method of claim 21, further comprising providing notice to said one or more clients when said second report is available.

25. The method of claim 24, further comprising providing notice to said one or more clients via electronic mail.

26. The method of claim 21, further comprising allowing said one or more clients to assign a username and password to each of said one or more users.

27. The method of claim 21, wherein said one or more clients comprise health care providers, and wherein said one or more users comprise patients.

28. The method of claim 21, wherein said information relates to one or more medical treatments.

29. The method of claim 22, further comprising storing said first report and said second report on said database.

30. A method for providing information and obtaining informed consent, said method comprising:
providing a database on a global computer network, said database containing said information;
providing access to said database to one or more users through said global computer network;
providing said one or more users with said information from said database;
receiving consent from said one or more users through said global computer network concerning said information; and
providing a report demonstrating said consent.

31. The method of claim 30, further comprising providing access to said database to a client.

32. The method of claim 31, further comprising providing said client with a second report demonstrating said consent.

33. The method of claim 30, wherein said information pertains to a surgical procedure.

34. The method of claim 30, wherein providing said one or more users with said information further comprises providing said information in a plurality of separate segments.

35. The method of claim 30, further comprising providing said information in at least one of a group consisting of written text, audio recordings, and visual representations.

36. The method of claim 30, further comprising allowing public access to a portion of said database.

37. The method of claim 36, further comprising providing access to a portion of said database to said one or more users that is not accessible to said public.

38. The method of claim 31, wherein said client comprises a health care provider.

39. The method of claim 38, wherein said one or more users comprise patients.

40. A method for providing information for use in obtaining informed consent, said method comprising:
providing a database on a global computer network, said database containing information regarding a plurality of treatments;
allowing a health care provider to provide access to said database to a patient through said global computer network;
allowing said patient to select at least one of said plurality of treatments;
providing said patient with information pertaining to said selected treatment from said database;
receiving feedback from said patient related to portions of said information pertaining to said selected treatment in which said patient desires additional information such that said health care provider and said patient can communicate to supplement said information pertaining to said selected treatment based on said feedback to obtain informed consent from said patient related to said selected treatment.

41. The method of claim 40, further comprising providing access to said database to said health care provider.

42. The method of claim 40, further comprising providing said patient with a first report of said feedback.

43. The method of claim 40, further comprising providing said health care provider with a second report of said feedback.

44. The method of claim 40, wherein providing said patient with information pertaining to said selected treatment further comprises providing information pertaining to a surgical procedure.

45. The method of claim 40, further comprising allowing public access to a portion of said database.

46. A method for providing information for use in obtaining informed consent, said method comprising:
providing a database, said database containing information regarding a plurality of treatments;
allowing a health care provider to provide access to said database to a patient;
allowing said patient to select at least one of said plurality of treatments;
providing said patient with information pertaining to said selected treatment from said database;
receiving feedback from said patient related to portions of said information pertaining to said selected treatment in which said patient desires additional information;
providing said patient with a first report of said feedback;
providing said health care provider with a second report of said feedback such that said health care provider and said patient can communicate to supplement said information pertaining to said selected treatment based on said feedback to obtain informed consent from said patient related to said selected treatment.

47. The method of claim 46, further comprising providing access to said database to said health care provider.

48. The method of claim 47, further comprising allowing said health care provider to access portions of said database not accessible to said patient.

49. The method of claim 47, further comprising preventing said health care provider from accessing data on said database pertaining to patients of other health care providers.

50. The method of claim 46, further comprising providing said database on a global computer network.

51. The method of claim 46, further comprising storing said first report and said second report on said database.

52. The method of claim 46, further comprising allowing public access to a portion of said database.

53. The method of claim 52, further comprising providing access to a portion of said database to said patient that is not accessible to said public or said health care provider.

54. A method for providing information, said method comprising:
providing a database on a global computer network, said database containing information regarding a plurality of treatments;
allowing a health care provider to provide access to said database to a patient through said global computer network;
allowing said patient to select at least one of said plurality of treatments;
providing said patient with information pertaining to said selected treatment from said database;
receiving feedback from said patient related to portions of said information pertaining to said selected treatment in which said patient desires additional information;
providing said patient with a first report of said feedback;
providing said health care provider with a second report of said feedback.

55. The method of claim 54, further comprising providing access to said database to said health care provider.

56. The method of claim 54, wherein said information relates to obtaining informed consent regarding said selected treatment.

57. The method of claim 56, further comprising receiving consent from said patient through said global computer network regarding said selected treatment.

58. The method of claim 54, further comprising sending notice to said health care provider through electronic mail when said second report is available.

59. The method of claim 54, further comprising providing subscriptions to a plurality of health care providers to utilize said database.

60. The method of claim 59, further comprising allowing said plurality of health care providers to enter identifying information regarding said patient to allow said patient to access said database.
